(19) United States
(12) Patent Application Publication
(10) Pub. No.: US 2013/0009023 A1
(43) Pub. Date: Jan. 10, 2013

(54) Carrier device for monitor

(75) Inventor: Hsin Hao Chen, Taipei (TW)

(73) Assignee: Kernan Technology Co., Ltd.

(21) Appl. No.: 13/135,502

(22) Filed: Jul. 7, 2011

(51) Int. Cl. F16M 11/10

(52) U.S. Cl. 248/125.8

(57) ABSTRACT

A carrier device includes a supporting base, two frames pivotally attached to the supporting base with spindles and each having a pivot axle, a mounting seat attached to the pivot axles of the frames and pivotal relative to the pivot axles of the frames between an upwardly extended working position and a storing position, a lock device is attached to the pivot axle of each of the frames for locking the frame to the supporting base at the lower folded position, and a latch device is attached to the frames for latching the mounting seat to the frames at the storing position and for preventing the carrier device from being collapsed.

### BACKGROUND OF THE INVENTION

1. Field of the Invention

The present invention relates to a carrier device for supporting various objects, such as monitors, keyboards, antenna members or the like, and more particularly to a carrier device including an improved structure for stably supporting the objects or the like at the selected or suitable angular position and including two latching or locking devices for preventing the carrier device from being collapsed.

2. Description of the Prior Art

Typical carrier devices for supporting such as monitors or antenna members or keyboards comprise a mounting seat for attaching or coupling to the monitors or the antenna members or the keyboards, and a movable seat and an engaging plate pivotally coupling the mounting seat to a carrier plate for pivotally coupling and supporting the monitors or the antenna members or the keyboards to the carrier plate and for adjustably supporting the monitors or the antenna members or the keyboards at the selected or suitable or predetermined angular position relative to the carrier plate.

For example, U.S. Pat. No. 5,901,933 to Lin, U.S. Pat. No. 5,941,497 to Inoue et al., U.S. Pat. No. 6,021,985 to Hahn, and U.S. Pat. No. 6,027,090 to Liu disclose several of the typical carrier devices each comprising a movable seat and an engaging plate disposed parallel to each other and pivotally coupled between a carrier plate and a mounting seat in which the mounting seat may be used for supporting the monitors or antenna members or keyboards, and thus for allowing the monitors or antenna members or keyboards and the carrier plate to be adjustably supported at the selected or suitable or predetermined angular position relative to the carrier plate.

However, the movable seat and the engaging plate are pivotally coupled between the carrier plate and the mounting seat with a spring member such that the spring member may sustain a great force or a great weight of the monitors or antenna members or keyboards and the carrier plate and such that the spring member may have a good chance to become failure after use. In addition, no suitable latching or locking devices have been provided for preventing the carrier device from being collapsed.

U.S. Pat. No. 7,413,152 to Chen discloses another typical support or carrier device comprising a support for supporting the monitors or the keyboards or the like thereon, and a frame and a link disposed parallel to each other and pivotally coupled between a base and the support for adjustably supporting the monitors or the keyboards at the selected or suitable or predetermined angular position relative to the base.

However, no suitable latching or locking devices have been provided for preventing the carrier device from being collapsed, and for allowing the carrier device to be easily and suitably operated or actuated by the user.

The present invention has arisen to mitigate and/or obviate the afore-described disadvantages of the conventional carrier devices for supporting the monitors or the displayers or the keyboards or the like.

### SUMMARY OF THE INVENTION

The primary objective of the present invention is to provide a carrier device including an improved structure for stably supporting the objects or the like at the selected or suitable angular position and including two latching or locking devices for preventing the carrier device from being collapsed.

In accordance with one aspect of the invention, there is provided a carrier device comprising a supporting base, two frames each pivotally attached to the supporting base with a spindle and pivotal relative to the supporting base between an upper unfolded position and a lower folded position, and each including a pivot axle parallel to the spindle, a mounting seat attached to the pivot axles of the frames and pivotal relative to the pivot axles of the frames between an upwardly extended working position and a storing position, a lock device attached to the pivot axle of each of the frames for locking the frame to the supporting base at the lower folded position, and a latch device attached to the frames for latching the mounting seat to the frames at the storing position.

The frames each include two linking plates attached to end portions of the pivot axle, and two levers pivotally coupled to each of the linking plates for forming a parallelepipedal structure for the frame.

The lock device includes a lock pin selectively engageable with the linking plate and the lever for locking the frame to the supporting base at the lower folded position. The lock device includes a carrying member attached to each of the pivot axles for supporting the lock pin.

The lock device includes a carriage and a follower rotatably attached to each of the pivot axles and secured together, the carriage includes a curved slot formed therein for selectively and slidably receiving and engaging with a first end of the lock pin, and the follower includes a curved channel formed therein for receiving and engaging with the lock pin.

The lock pin includes an actuating projection, the follower includes a cam surface formed in the curved channel for engaging with the actuating projection, and the cam surface of the follower includes a shallower end for moving the actuating projection of the lock pin out of the follower, and includes a deeper end where the actuating projection of the lock pin is engageable into the follower and engageable with the cam surface of the follower.

The mounting seat is secured to the carriages. The carriage includes a lock notch formed therein, the latch device includes two pivotal arms each having a first end for selectively engaging with the lock notch of the follower. The latch device includes an actuating knob for engaging with the arms and for disengaging the first ends of the arms from the lock notch of the follower.

The latch device includes a casing mounted between the frames, the arms are each pivotally attached to the casing with a pivot pin, and the actuating knob is slidably engaged with the casing and engaged with a second end of the arms. The carriage and the follower are secured together with a fastener.

The linking plates each include an orifice formed therein, and the levers each include an aperture formed therein, the lock pin includes an end portion selectively engaging with the orifice of the linking plate and the aperture of the lever.

The lock device includes a washer attached to the pivot axle of each of the frames and secured to the mounting seat. The frames each include two linking plates attached to end portions of the spindle and coupled to the levers for forming the parallelepipedal structure for the frame.

The frames each include a spring biasing member attached to the spindle and engaged between the supporting base and the frame for biasing and forcing the frame upwardly to the upper unfolded position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a carrier device in accordance with the present invention for supporting a monitor or displayer or antenna member or keyboard or the like;

FIG. 2 is a partial exploded view of the carrier device;

FIG. 3 is a partial perspective view of the carrier device;

FIG. 4 is another partial exploded view of the carrier device;

FIG. 5 is another enlarged partial perspective view of the carrier device;

FIG. 6 is a further enlarged partial perspective view of the carrier device;

FIG. 7 is a partial top plan schematic view of the carrier device;

FIG. 8 is a partial exploded view of the carrier device; and

FIGS. 9, 10, 11 are enlarged partial perspective views similar to FIG. 3, illustrating the operation of the carrier device.

### DETAILED DESCRIPTION OF THE PREFERRED EMBODIMENT

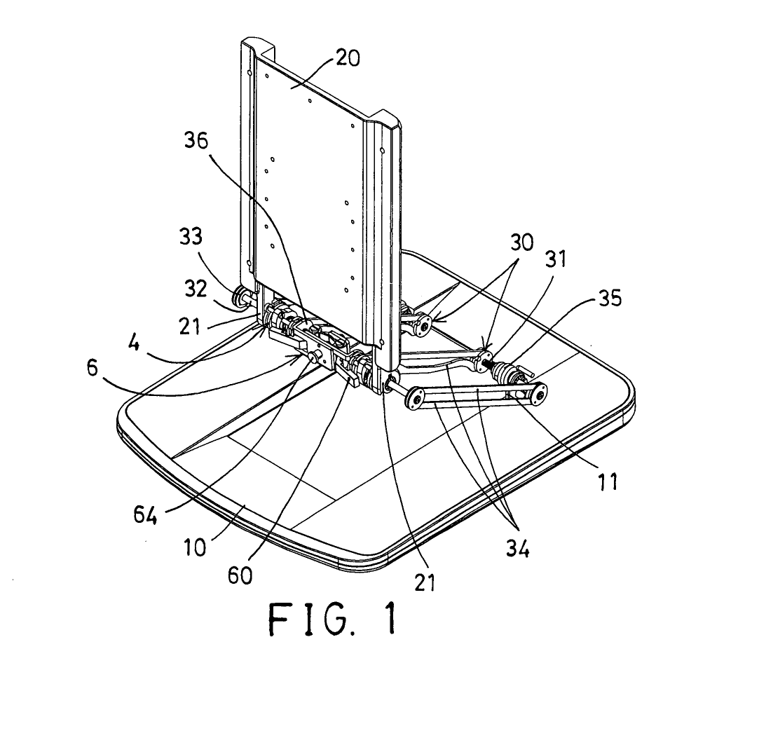

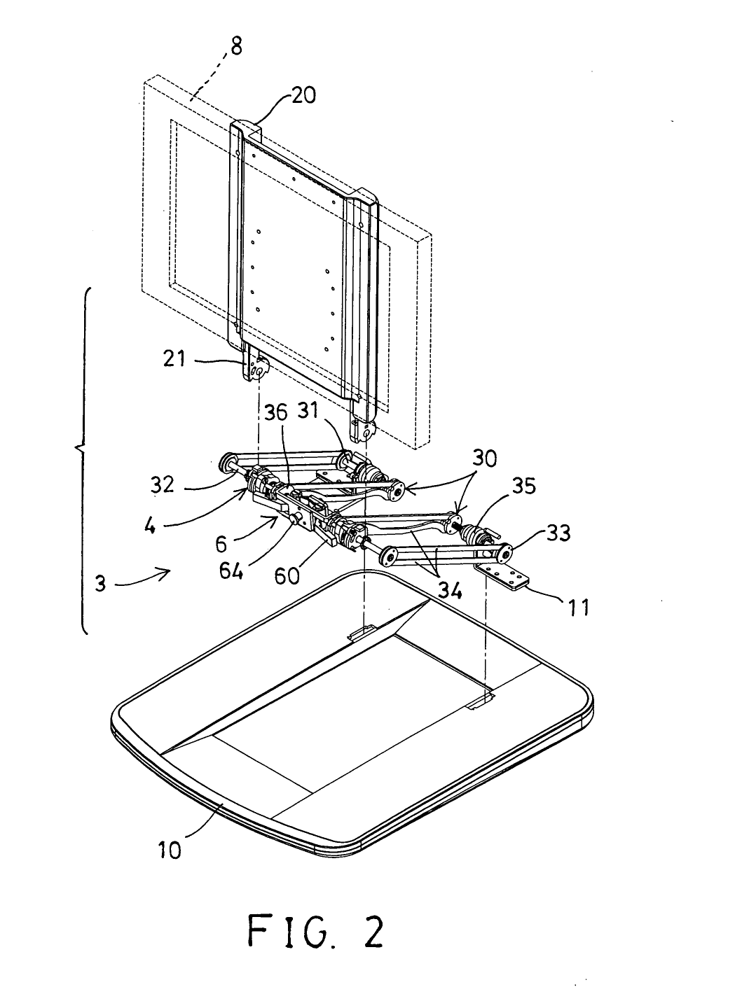

Referring to the drawings, and initially to FIGS. 1-3, a carrier device 1 in accordance with the present invention is provided for supporting various objects 8, such as displayers, monitors 8 (FIG. 2), antenna members or keyboards, or the like, and for adjustably supporting the monitors 8 or the displayers or the keyboards at the selected or suitable or predetermined angular position relative to the supporting table (not shown) or the like, and comprises a supporting base 10 including one or more (such as two) brackets 11 attached to or extended from the supporting base 10. A mounting seat 20 is to be rotatably or pivotally coupled to the supporting base 10 with a mount linkage or fixture 3 for foldably and adjustably coupling or attaching or supporting or securing the object 8 to the supporting base 10.

The mount fixture 3 includes one or more (such as two) frames 30 each having a spindle 31 pivotally or rotatably attached or mounted or engaged onto the supporting base 10, such as attached or mounted to the brackets 11 of the supporting base 10 respectively, a pivot axle 32 disposed parallel to the spindle 31, two pairs of washers or discs or end or linking plates 33 attached or mounted to the end portions of the spindle 31 and the pivot axle 32 respectively, and two pairs of beams or levers 34 pivotally or rotatably attached or mounted or coupled between the linking plates 33 for forming or defining a parallelepipedal structure for the frame 30, and for allowing the frames 30 to be pivoted or rotated relative to the supporting base 10 between an upper unfolded working position and a lower folded storing position. It is to be noted that a single linking plate 33 may be attached or mounted or secured to each of the end portions of the spindle 31 and the pivot axle 32, instead of a pair of linking plates 33. The mounting seat 20 includes one or more (such as two) legs or extensions 21 pivotally or rotatably attached or mounted or secured to the pivot axles 32 and pivotal relative to the mounting seat 20 between an upwardly extended or vertical or working position and a substantially horizontally extended or horizontal storing or folding position.

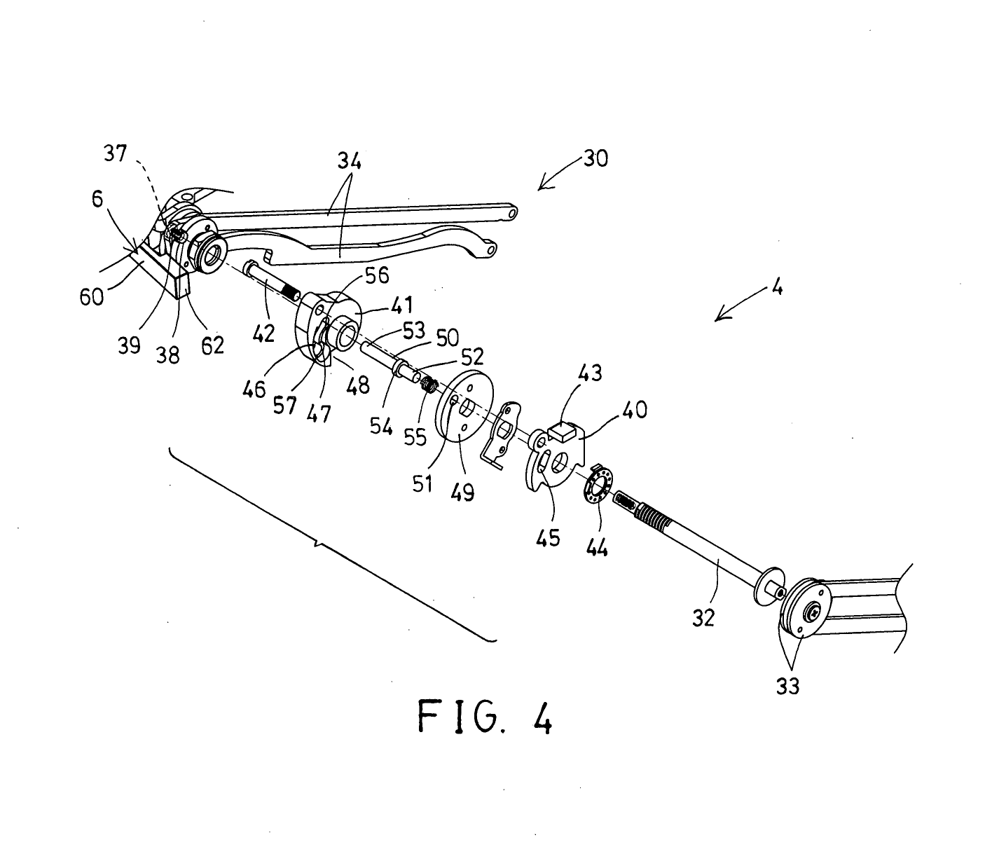

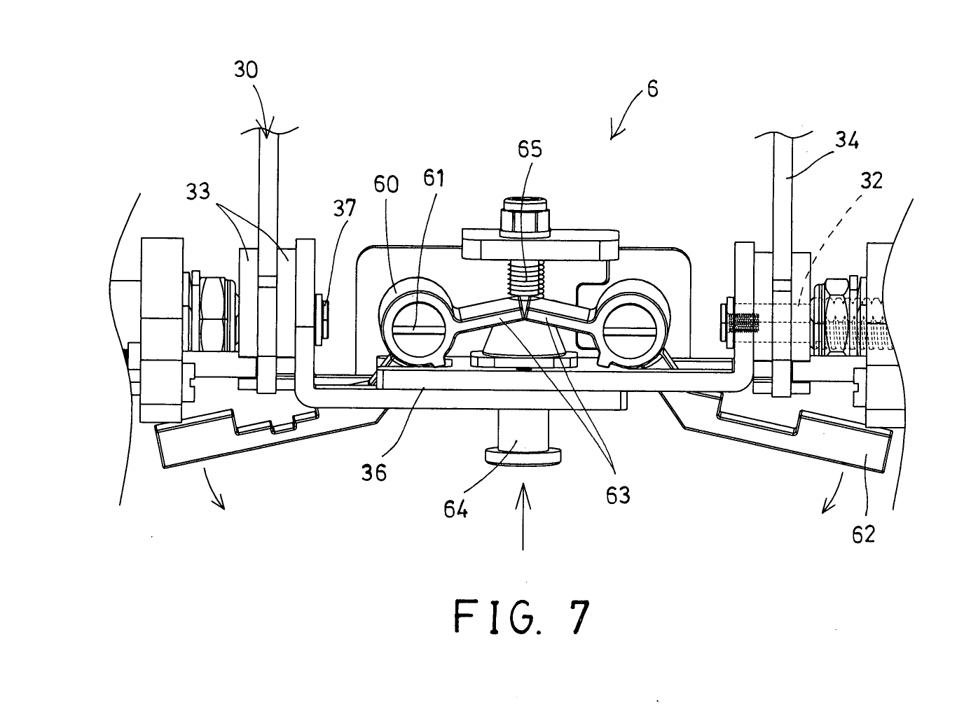

The pivot axle 32 is mounted or secured to the linking plates 33 and rotated in concert with the linking plates 33 when the frame 30 is pivoted or rotated upwardly or downwardly relative to the supporting base 10, and the frames 30 each include a spring biasing member 35 attached or mounted or engaged onto the respective spindle 31 and engaged between the supporting base 10 and the frame 30 for biasing or moving or forcing the frame 30 upwardly to the vertical or working position. A support or casing 36 is attached or mounted or secured between the frames 30, such as attached or mounted or secured between the linking plates 33 or the pivot axles 32 of the frames 30 with fasteners 37 respectively (FIGS. 4, 7) for allowing the casing 36 also to be pivoted or rotated upwardly or downwardly relative to the supporting base 10 together with the pivot axles 32 or the frames 30.

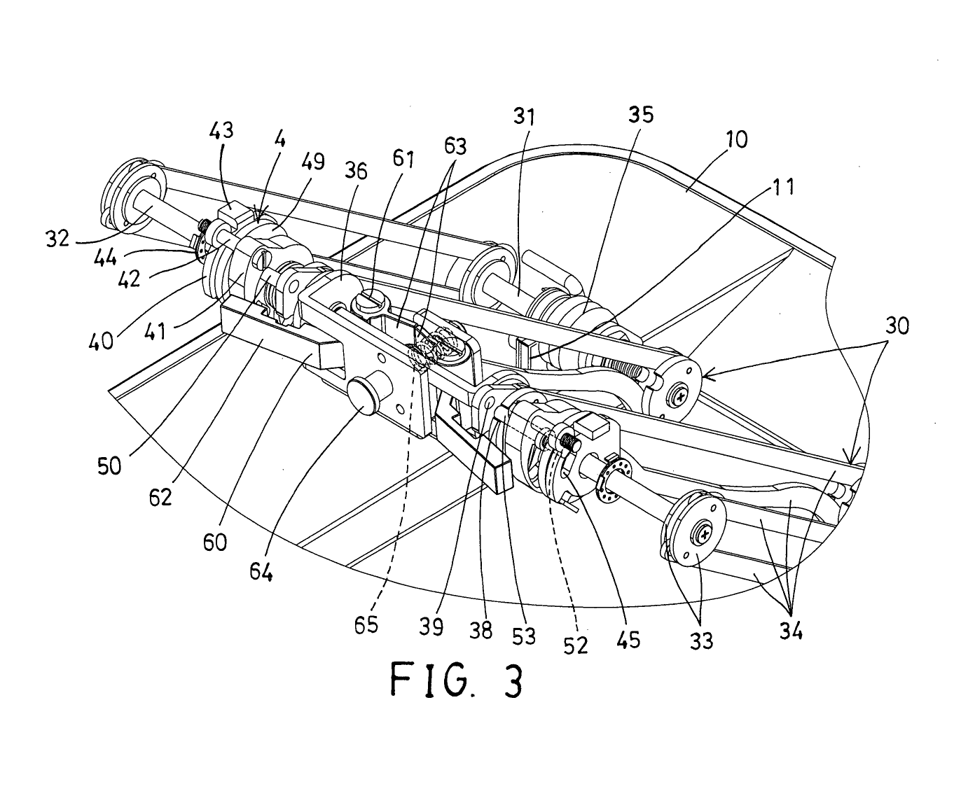

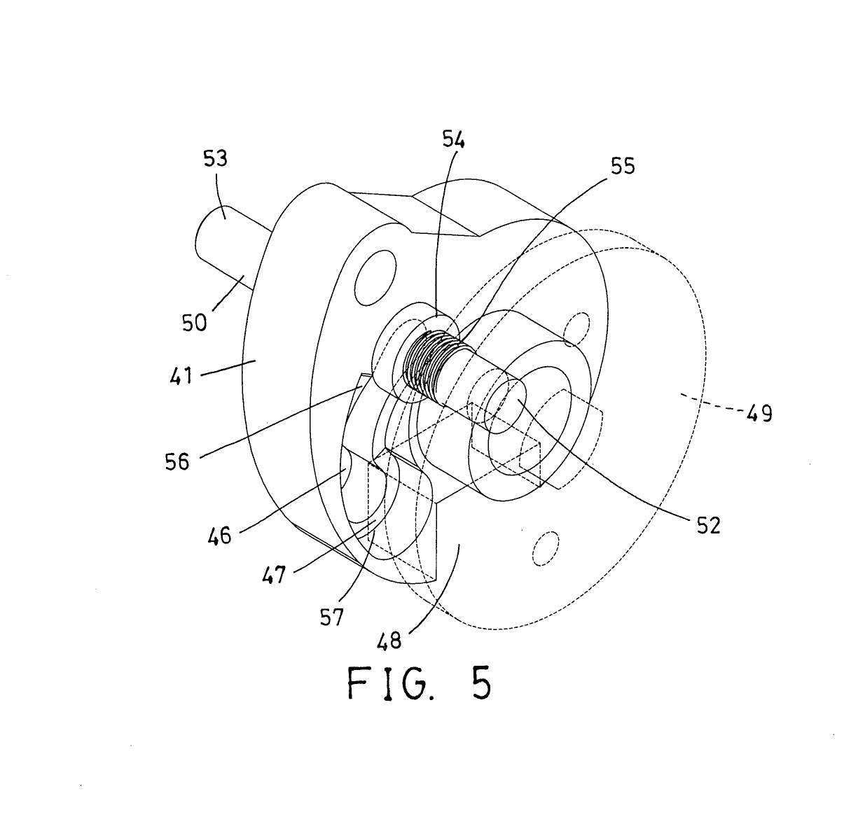

A lock mechanism or device 4 is attached or mounted or secured onto the pivot axle 32 of each of the frames 30 for locking the frames 30 to the supporting base 10 at the storing or folding position. As shown in FIGS. 3-5, the lock devices 4 each include a carriage 40 and a follower 41 pivotally or rotatably attached or mounted or secured to the respective pivot axle 32, and the carriage 40 and the follower 41 are secured together with a latch or lock or fastener 42 for allowing the carriage 40 and the follower 41 to be pivoted or rotated relative to the pivot axle 32 in concert with each other. The carriage 40 includes a key or projection or ear 43 extended outwardly therefrom for engaging with the respective leg or extension 21 of the mounting seat 20 and for anchoring or securing the carriage 40 to the mounting seat 20 and for allowing the mounting seat 20 to be pivoted or rotated relative to the pivot axle 32 in concert with the carriage 40 and the follower 41.

A washer 44 may further be provided and pivotally or rotatably attached or mounted or secured to the respective pivot axle 32 and engaged with the respective leg or extension 21 of the mounting seat 20 for further solidly and stably anchoring or securing the mounting seat 20 to the pivot axle 32. The carriage 40 includes an oblong or curved slot 45 formed therein, and the follower 41 also includes an oblong or curved channel 46 formed therein and substantially parallel to the curved slot 45 of the carriage 40. The follower 41 includes an inclined or tilted cam surface 47 formed or provided therein, such as formed in the curved channel 46 of the follower 41, and includes a lock notch 48 formed therein. The lock device 4 further includes a carrying member 49 attached or mounted or secured to the respective pivot axle 32 and keyed to the pivot axle 32 and rotated in concert with the pivot axle 32 and disposed or located between the carriage 40 and the follower 41.

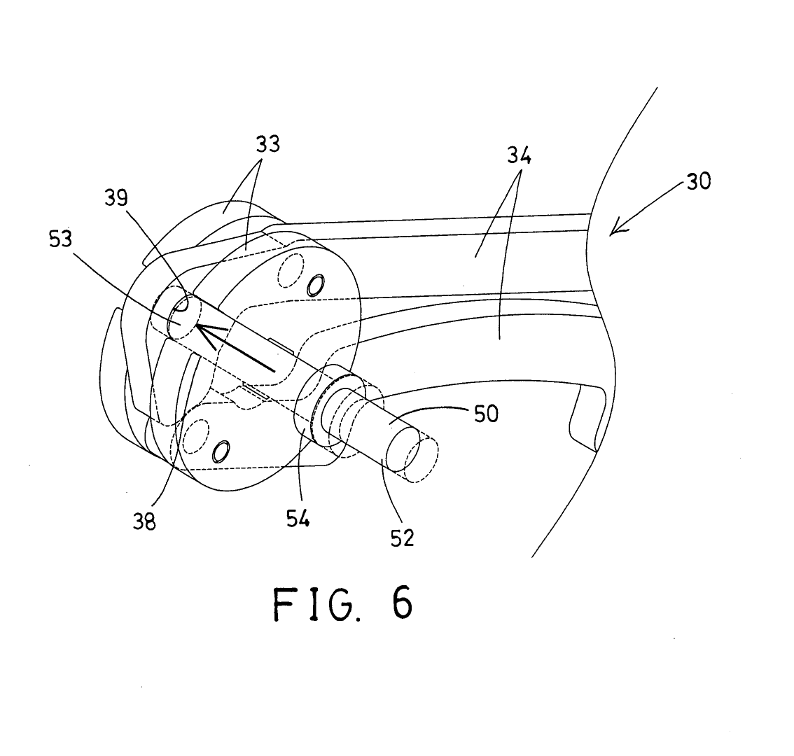

The lock device 4 further includes a lock pin 50 slidably received or engaged into or through an engaging hole 51 of the carrying member 49 and disposed or arranged substantially parallel to the pivot axle 32, and the lock pin 50 includes one or first end 52 selectively and slidably received or engaged into the curved slot 45 of the carriage 40 which may guide and limit the carrying member 49 to pivot or to rotate relative to the carriage 40 and the follower 41, and includes the other or second end 53 for selectively engaging with an orifice 38 of one of the linking plates 33 and an aperture 39 of one of the levers 34 (FIG. 6), and includes an actuating projection 54 formed or provided on the middle portion thereof (FIGS. 4-6) for selectively engaging with the inclined or tilted cam surface 47 of the follower 41 (FIGS. 3, 5, 9, 10), and includes a spring biasing member 55 attached or mounted or engaged onto the lock pin 50 and engaged with the actuating projection 54 for biasing or forcing the actuating projection 54 to selectively engage with the inclined or tilted cam surface 47 of the follower 41, and also for biasing or forcing the other end 53 of the lock pin 50 to selectively engage with the orifice 38 of the linking plate 33 and the aperture 39 of the lever 34 (FIG. 6).

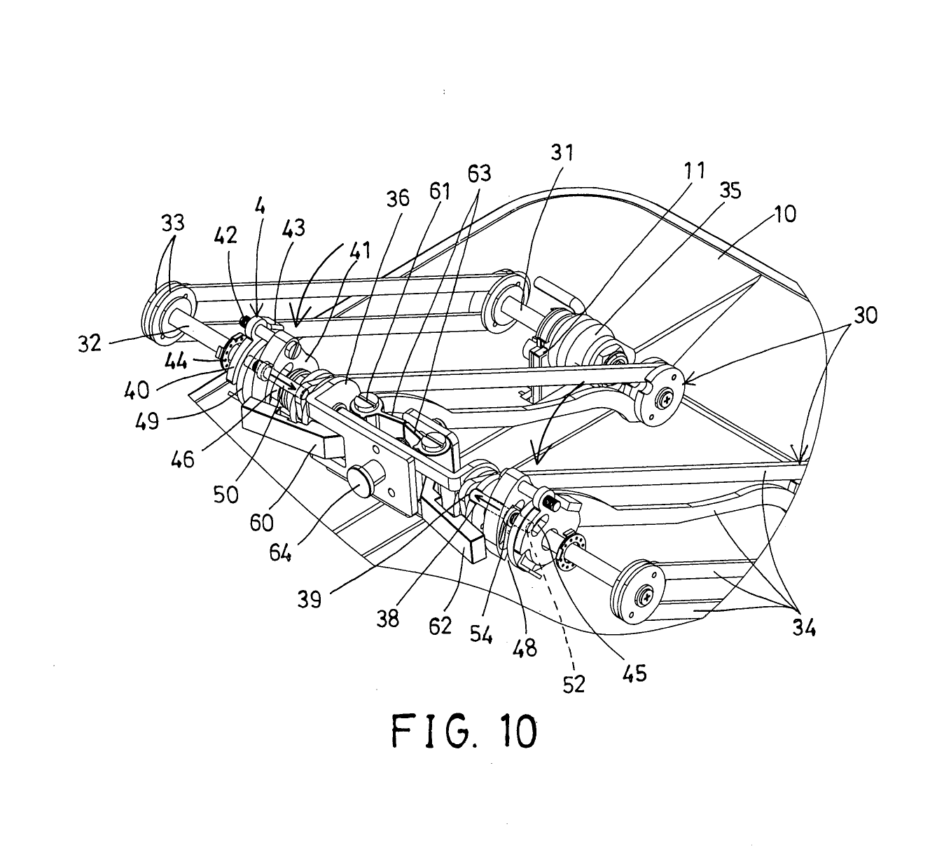

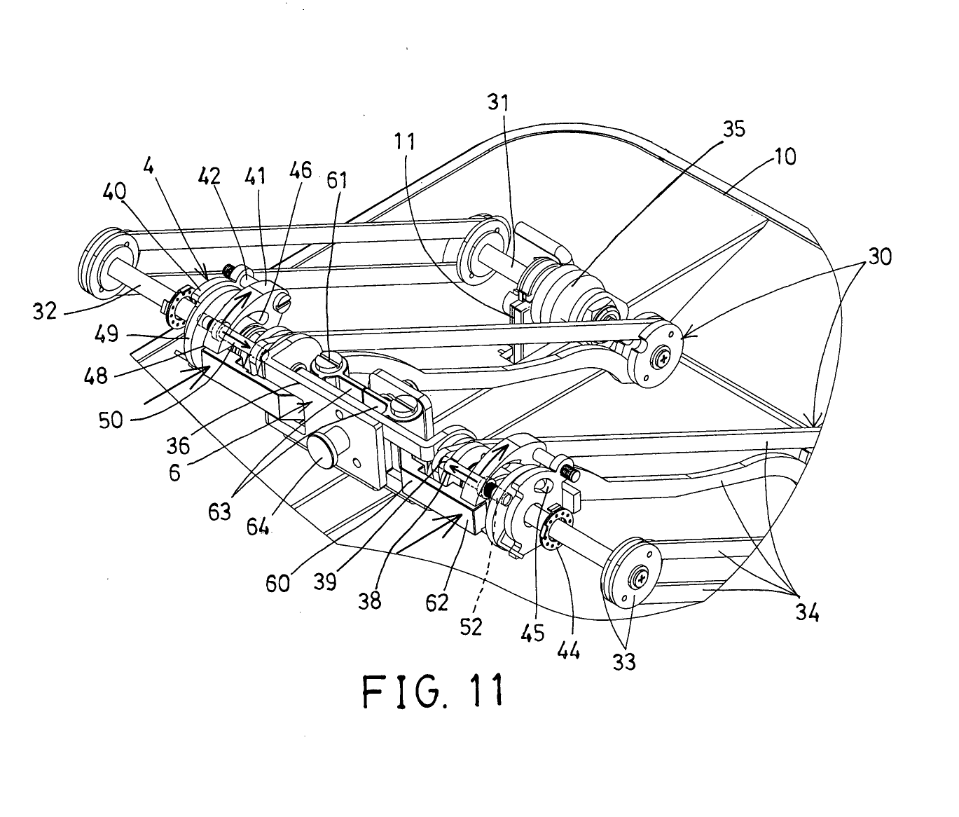

As shown in FIGS. 4-5, and 8, the inclined or tilted cam surface 47 of the follower 41 includes a first or shallower end 56 where the actuating projection 54 of the lock pin 50 is located outside of the follower 41, and includes a second or wider or deeper end 57 where the actuating projection 54 of the lock pin 50 is engageable into the follower 41 and engageable with the inclined or tilted cam surface 47 of the follower 41. When the actuating projection 54 of the lock pin 50 is located outside of the follower 41 (FIGS. 3, 5, 9), the one or first end 52 of the lock pin 50 is slidably received or engaged into the curved slot 45 of the carriage 40 which may guide and limit the carrying member 49 to pivot or to rotate relative to the carriage 40 and the follower 41, and when the actuating projection 54 of the lock pin 50 is engaged into the follower 41 and engaged with the inclined or tilted cam surface 47 of the follower 41 (FIGS. 10, 11), the one or first end 52 of the lock pin 50 is disengaged from the carriage 40, and the other or second end 53 of the lock pin 50 is engaged into the aperture 39 of the lever 34 in order to lock and latch the parallelepipedal levers 34 of the frames 30 in place.

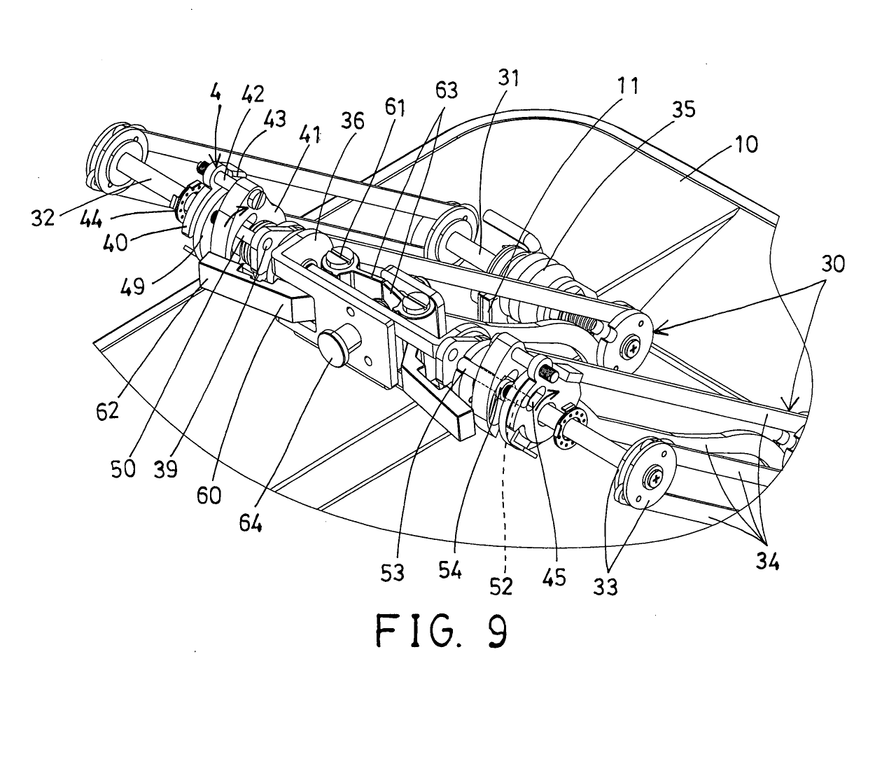

In operation, as shown in FIGS. 3 and 9, when the one or first end 52 of the lock pin 50 is slidably received or engaged into the curved slot 45 of the carriage 40, and when the other or second end 53 of the lock pin 50 is disengaged from the lever 34, the mounting seat 20 and the monitor or the object 8 and the frames 30 may be pivoted or rotated or moved or adjusted up and down relative to the supporting base 10 to any selected positions. When the frames 30 are pivoted or rotated downwardly toward the supporting base 10 to the substantially horizontal and folded position, the other or second end 53 of the lock pin 50 may be biased to engage into the aperture 39 of the lever 34 (FIGS. 6, 10) and may lock and latch the parallelepipedal levers 34 of the frames 30 in place and may prevent the frames 30 from being further rotated relative to the supporting base 10, at this time, the mounting seat 20 and the monitor or the object 8 may no longer be moved downwardly toward the supporting base 10.

At this moment, the mounting seat 20 and the carriage 40 and the follower 41 may be pivoted or rotated relative to the frames 30 and toward or to engage with the frames 30 at the substantially horizontally extended or storing or folding position, and/or the follower 41 and the carriage 40 may further be pivoted or rotated relative to the pivot axle 32 when the mounting seat 20 is pivoted or rotated toward or to engage with the frames 30. The carrier device 1 further includes a latch mechanism or device 6 attached or mounted or secured to the frames 30 or the casing 36 for locking or latching the mounting seat 20 and/or the follower 41 and the carriage 40 to the frames 30 at the substantially horizontally extended or storing or folding position.

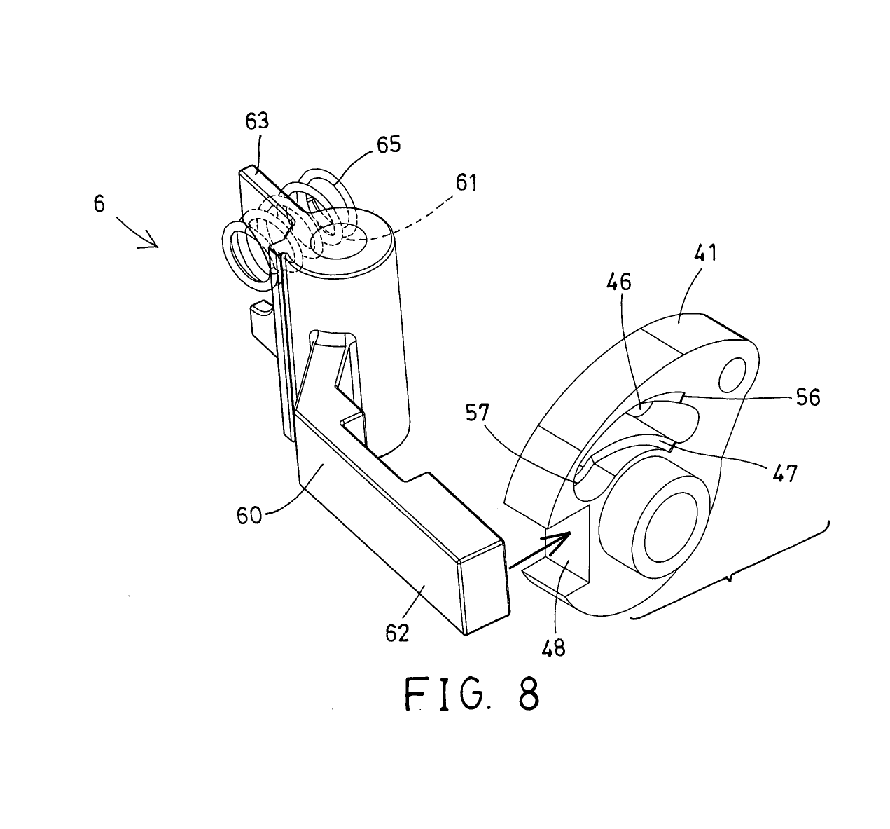

For example, as shown in FIGS. 3, 7-11, the latch device 6 includes one or more (such as two) arms 60 each having a middle portion pivotally or rotatably attached or mounted or secured to the casing 36 with a pivot pin 61, the arms 60 each include one or first end 62 extended out of the casing 36 for selectively engaging with the lock notch 48 of the follower 41 (FIGS. 8, 11), and each include the other or second end 63 located in the casing 36 (FIGS. 3, 7, 9-11) for selectively engaging with an actuating knob 64 and a spring biasing member 65 (FIGS. 3, 7). For example, the actuating knob 64 is slidably received or engaged with the casing 36 and contacted or engaged with the other or second ends 63 of the arms 60 for moving or forcing the other or second ends 63 of the arms 60 toward or onto the spring biasing member 65, and relatively, the spring biasing member 65 may bias and force the other or second ends 63 of the arms 60 to engage with the actuating knob 64 and to move or force the actuating knob 64 out of the casing 36.

In operation, as shown in FIG. 11, when the mounting seat 20 is pivoted or rotated toward or to engage with the frames 30 at the substantially horizontally extended or storing or folding position, the follower 41 and the carriage 40 may be pivoted or rotated relative to the pivot axle 32 until the lock notch 48 of the follower 41 is aligned with or directed toward the one or first end 62 of the arm 60. At this moment, or when the lock notch 48 of the follower 41 is aligned with or directed toward the one or first end 62 of the arm 60, the one or first ends 62 of the arms 60 may be biased and forced to engage into the lock notches 48 of the followers 41 in order to latch or lock the follower 41 and the carriage 40 and the mounting seat 20 to the frames 30 at the substantially horizontally extended or storing or folding position.

When it is required to release the mounting seat 20 and to allow the mounting seat 20 and the carriage 40 and the follower 41 to pivot or rotate relative to the pivot axle 32 and the frames 30 toward the upwardly extended or vertical or working position, it is only required to depress the actuating knob 64 into the casing 36 and to depress or force or move the other or second ends 63 of the arms 60 toward or onto the spring biasing member 65 (FIG. 7), the one or first ends 62 of the arms 60 may be forced to be disengaged from the lock notches 48 of the followers 41 and thus to allow the mounting seat 20 and the carriage 40 and the follower 41 to pivot or rotate relative to the pivot axle 32 and the frames 30 toward the upwardly extended or vertical or working position.

At this moment, or when the mounting seat 20 and the carriage 40 and the follower 41 are pivoted or rotated relative to the pivot axle 32 and the frames 30 toward the upwardly extended or vertical or working position, the actuating projection 54 of the lock pin 50 may be forced to move from the second or wider or deeper end 57 of the inclined or tilted cam surface 47 toward the first or shallower end 56 of the inclined or tilted cam surface 47 of the follower 41, and the one or first end 52 of the lock pin 50 forced or moved to engage into the curved slot 45 of the carriage 40 again, and the other or second end 53 of the lock pin 50 may be forced to move away from and may be disengaged from the linking plates 33 and the levers 34 in order to release the linking plates 33 and the levers 34 or the frames 30, and thus to allow the mounting seat 20 and the frames 30 to be pivoted or rotated or moved or adjusted up and down relative to the supporting base 10 to the selected positions.

Accordingly, the carrier device includes an improved structure for stably supporting the objects or the like at the selected or suitable angular position and includes two latching or locking devices for preventing the carrier device from being collapsed.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A carrier device comprising:
a supporting base,
two frames each pivotally attached to said supporting base with a spindle and pivotal relative to said supporting base between an upper unfolded position and a lower folded position, and each including a pivot axle parallel to said spindle,
a mounting seat attached to said pivot axles of said frames and pivotal relative to said pivot axles of said frames between an upwardly extended working position and a storing position,
a lock device attached to said pivot axle of each of said frames for locking said frame to said supporting base at said lower folded position, and
a latch device attached to said frames for latching said mounting seat to said frames at said storing position.

2. The carrier device as claimed in claim 1, wherein said frames each include two linking plates attached to end portions of said pivot axle, and two levers pivotally coupled to each of said linking plates for forming a parallelepipedal structure for said frame.

3. The carrier device as claimed in claim 2, wherein said lock device includes a lock pin selectively engageable with said linking plate and said lever for locking said frame to said supporting base at said lower folded position.

4. The carrier device as claimed in claim 3, wherein said lock device includes a carrying member attached to each of said pivot axles for supporting said lock pin.

5. The carrier device as claimed in claim 3, wherein said lock device includes a carriage and a follower rotatably attached to each of said pivot axles and secured together, said carriage includes a curved slot formed therein for selectively and slidably receiving and engaging with a first end of said lock pin, and said follower includes a curved channel formed therein for receiving and engaging with said lock pin.

6. The carrier device as claimed in claim 5, wherein said lock pin includes an actuating projection, said follower includes a cam surface formed in said curved channel for engaging with said actuating projection, and said cam surface of said follower includes a shallower end for moving said actuating projection of said lock pin out of said follower, and includes a deeper end where said actuating projection of said lock pin is engageable into said follower and engageable with said cam surface of said follower.

7. The carrier device as claimed in claim 5, wherein said mounting seat is secured to said carriages.

8. The carrier device as claimed in claim 7, wherein said carriage includes a lock notch formed therein, said latch device includes two pivotal arms each having a first end for selectively engaging with said lock notch of said follower.

9. The carrier device as claimed in claim 8, wherein said latch device includes an actuating knob for engaging with said arms and for disengaging said first ends of said arms from said lock notch of said follower.

10. The carrier device as claimed in claim 9, wherein said latch device includes a casing mounted between said frames, said arms are each pivotally attached to said casing with a pivot pin, and said actuating knob is slidably engaged with said casing and engaged with a second end of said arms.

11. The carrier device as claimed in claim 5, wherein said carriage and said follower are secured together with a fastener.

12. The carrier device as claimed in claim 3, wherein said linking plates each include an orifice formed therein, and said levers each include an aperture formed therein, said lock pin includes an end portion selectively engaging with said orifice of said linking plate and said aperture of said lever.

13. The carrier device as claimed in claim 3, wherein said lock device includes a washer attached to said pivot axle of each of said frames and secured to said mounting seat.

14. The carrier device as claimed in claim 2, wherein said frames each include two linking plates attached to end portions of said spindle and coupled to said levers for forming said parallelepipedal structure for said frame.

15. The carrier device as claimed in claim 1, wherein said frames each include a spring biasing member attached to said spindle and engaged between said supporting base and said frame for biasing and forcing said frame upwardly to said upper unfolded position.
